(19) United States
(12) Patent Application Publication
(10) Pub. No.: US 2016/0302246 A1
(43) Pub. Date: Oct. 13, 2016

(54) DEVICE-TO-DEVICE RECEIVE WINDOW SELECTION FOR INTER-CELL OPERATION

(71) Applicant: Intel Corporation, Santa Clara, CA (US)

(72) Inventors: Andrey CHERVYAKOV, Nizhny Novgorod (RU); Alexey KHORYAEV, Nizhny Novgorod (RU); Dmitry BELOV, Nizhny Novgorod (RU); Sergey SOSNIN, Zavolzhie (RU); Yang TANG, Pleasanton, CA (US)

(21) Appl. No.: 14/973,349

(22) Filed: Dec. 17, 2015

Related U.S. Application Data
(60) Provisional application No. 62/145,078, filed on Apr. 9, 2015.

(51) Int. Cl. H04W 76/02; H04W 72/04; H04W 72/12; H04L 5/14; H04W 56/00

(52) U.S. Cl. CPC H04W 76/023; H04L 5/1469; H04W 56/0045; H04W 72/1278; H04W 72/0446

(57) ABSTRACT

Embodiments of the present disclosure describe methods and apparatuses for receiver timing window selection for inter-cell operations. Other embodiments may be described and claimed.

### CROSS REFERENCE TO RELATED APPLICATIONS

The present application claims priority to U.S. Provisional Application No. 62/145,078, filed Apr. 9, 2015 and entitled “Method of D2D Receiver Timing Window Selection for Inter-Cell D2D Operation,” the entire disclosure of which is hereby incorporated by reference for all purposes.

### FIELD

Embodiments of the present disclosure generally relate to the field of wireless communication, and more particularly, to apparatuses and methods for device-to-device receive window selection for inter-cell operation.

### BACKGROUND

The device-to-device (D2D) air interface and, specifically, sidelink (SL) interface, were introduced in Long Term Evolution (LTE) Release 12. The D2D operation is expected to be supported in a variety of different deployment scenarios including in-coverage, partial-coverage, and out-of-coverage conditions.

An in-coverage condition may apply to: intra-cell (both D2D transmitter (TX) and receiver (RX) nodes being located inside network coverage and associated with the same cell); synchronous inter-cell (both D2D TX/RX nodes located inside network coverage and associated with different synchronous cells); and asynchronous inter-cell (both D2D TX/RX nodes located inside network coverage and associated with different time domain asynchronous cells).

A partial-coverage condition may apply to a first scenario in which a D2D TX node is located inside network coverage and the D2D RX node is located out of network coverage. The partial-coverage condition may alternatively apply to a second scenario in which a D2D TX node is located out of network coverage and the D2D RX node is located inside network coverage.

An out-of-coverage condition may apply when both the D2D TX/RX nodes are located out of network coverage.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a communication environment in accordance with some embodiments.

FIG. 2 illustrates a timing model in accordance with some embodiments.

FIG. 3 illustrates a timing model in accordance with some embodiments.

FIG. 4 illustrates an electronic device circuitry in accordance with some embodiments.

FIG. 5 is a flowchart depicting a receive window determination operation in accordance with some embodiments.

FIG. 6 is a graph illustrating concepts in accordance with some embodiments.

FIG. 7 is a system in accordance with some embodiments.

FIG. 8 is a computing apparatus in accordance with some embodiments.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A or B” means (A), (B), or (A and B). For the purposes of the present disclosure, the phrase “A, B, or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

User equipment (UE) receivers may be designed to ensure proper D2D demodulation performance in all the deployment scenarios described above. One factor that may need to be taken into account is receive signal timing. From the receiver implementation perspective, it is important to properly adjust the timing of a receive fast Fourier transform (FFT) window and also support timing errors/offsets handling. For D2D signals, both transmit signal timing model and propagation timing statistics may be different compared to conventional wireless access network (WAN) communication. In many cases, D2D receivers may rely on post-FFT compensation of time offsets. This may impose certain challenges for D2D receiver implementations and lead to reduced D2D demodulation performance.

LTE Technical Specifications (TSs) define procedures for D2D transmit signal timing only. The D2D receive signal timing, for example, the timing reference for the start of the D2D signal reception, may not be defined and may be up to UE implementation. However, the D2D receive signal timing may have a direct impact on demodulation performance and its implementation may be controlled with relatively few UE demodulation requirements.

Embodiments of the present disclosure describe methods and devices for D2D receive window selection (including adjustment) for inter-coverage, inter-cell D2D operation in synchronous or asynchronous networks.

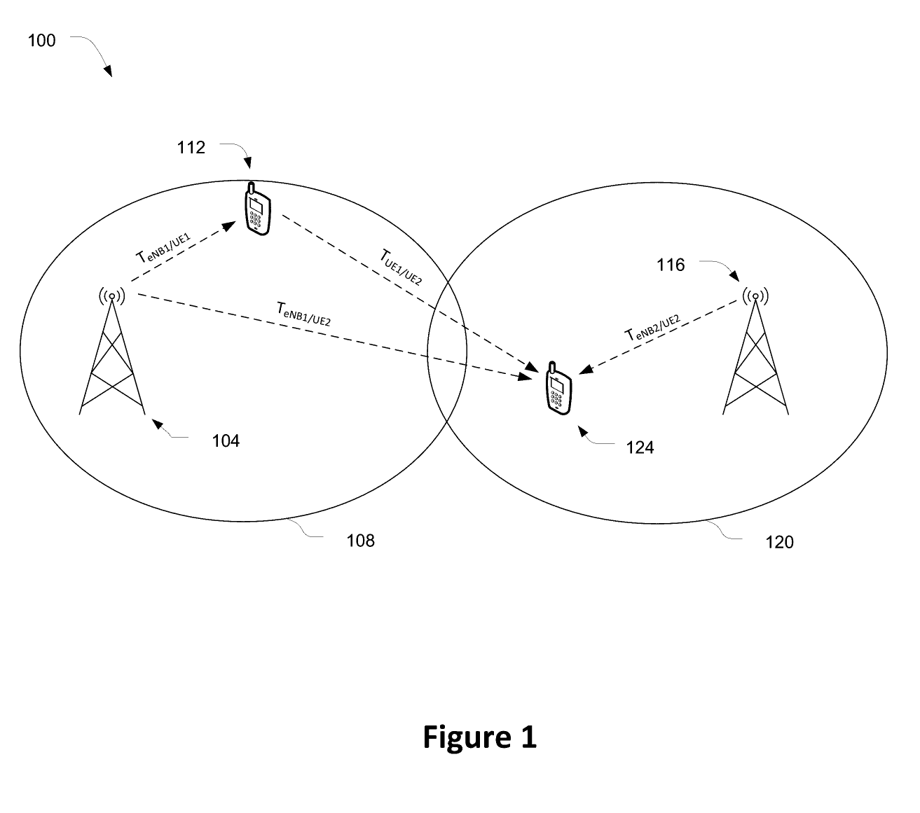

FIG. 1 illustrates a communication environment 100 in accordance with some embodiments. The communication environment 100 may include an evolved node B (eNB) 104 that provides a cell 108. A UE 112 may be attached to, for example communicatively coupled with, the cell 108. In this context, the cell 108 may be referred to as a serving cell of the UE 112. The UE 112 may derive time and frequency synchronization by processing primary synchronization signals (PSSs), secondary synchronization signals (SSSs), and channel reference signal (CRSs) of the cell 108.

The communication environment 100 may also include an eNB 116 that provides a cell 120. A UE 124 may be attached to the cell 120. In this context, the cell 120 may be referred to as a serving cell of the UE 124. The UE 124 may derive time and frequency synchronization by processing PSSs/SSSs/CRSs of the cell 120.

In some embodiments, the eNBs 104 and 116 may be part of an evolved universal terrestrial radio access network (EUTRAN) that provides a radio interface consistent with specifications and protocols developed by the 3^{rd} Generation Partnership Project (3GPP) including, but not limited to, LTE TSs. As used herein, “LTE” may refer generically to releases associated with the original LTE, LTE-Advanced (LTE-A), 5G, etc. In other embodiments, the eNBs 104 and 116 may be part of other cellular systems such as, but not limited to, Global System for Mobile Communication (GSM), General Packet Radio Service (GPRS), Universal Mobile Telecommunications System (UMTS), High Speed Packet Access (HSPA), Evolved HSPA (E-HSPA), etc.

The eNBs 104 and 116 may be in a time synchronous or asynchronous relationship with one another. If the eNBs 104 and 116 are in a synchronous relationship with one another, the communication environment 100 may be referred to as a synchronous inter-cell embodiment. If the eNBs 104 and 116 are in an asynchronous relationship with one another, the communication environment 100 may be referred to as an asynchronous inter-cell embodiment.

The signal propagation times between the various components of the communication environment 100 are illustrated in FIG. 1. In particular, a signal propagation time: between the eNB 104 (also referred to as “eNB1”) and the UE 112 (also referred to as “UE1”) is indicated by T_{eNB1/UE1}; between the eNB 104 and the UE 124 (also referred to as “UE2”) is indicated by T_{eNB1/UE2}; between the eNB 116 (also referred to as “eNB2”) and the UE 124 is indicated by T_{eNB2/UE2}; and between the UE 112 and UE 124 is indicated by T_{UE1/UE2}.

In addition to having communication links established with respective eNBs, the UEs may have sidelinks established with one another to communicate in a D2D manner. For purposes of the present description, the UE 112 may be referred to as the D2D TX and the UE 124 may be referred to as the D2D RX. However, it will be understood that each of these UEs may have both receive and transmit capabilities for both D2D and cellular communications.

The UE 124 may determine a receive window to receive D2D signals from the UE 112. The receive window may be a selected interval over which a receiver in the UE 124 is to process received waveforms to recover the transmitted D2D signal. The processing may include applying an FFT function to the waveforms and, therefore, the receive window may, in some embodiments, also be referred to as an FFT window.

Selecting a receive window may depend on a D2D transmission type. If the D2D transmission type is a physical sidelink shared channel (PSSCH) Mode 1 transmission, downlink (DL)-based D2D signal transmit timing may be used. If the D2D transmission type is with respect to any other D2D physical channel (for example, PSSCH Mode 2, physical sidelink control channel (PSCCH), or physical sidelink discovery channel (PSDCH)), uplink (UL)-based D2D signal transmit timing may be used.

The DL-based D2D signal transmit timing may refer to a procedure in which the D2D signal transmission takes place at a time T_{D2D}_{_}_{TX} that may be chosen based on a WAN DL receive timing reference point. The UL-based D2D signal transmit timing may refer to a procedure in which the D2D signal transmission takes place at a time T_{D2D}_{_}_{TX} that may be based on a WAN UL transmit timing reference point.

The DL- or UL-based D2D signal transmit timing may be consistent with Proximity Services (ProSe) UE transmission timing descriptions provided in 3GPP TS 36.133 Release 12.7.0, section 7.16.2 (Apr. 3, 2015). In particular, this description provides that sidelink transmissions take place (N_{TA,SL}+N_{TA offset})*T_{S} before the reception of the first detected path (in time) of the corresponding downlink frame from the reference cell, where N_{TA offset} is specified in section 8.1 of 3GPP TS 36.211 Release 12.5.0 (Mar. 26, 2015) and is the time division duplex (TDD) specific offset (0 for frequency division duplex (FDD)), with N_{TA,SL}=0 for the DL-based D2D transmit timing and N_{TA,SL}=N_{TA} for the UL-based D2D transmit timing. N_{TA} is a timing offset between uplink and downlink radio frames at a UE consistent with definition in Section 3.1 in TS 36.211; N_{TA offset} is a fixed timing advance offset consistent with definition in clause 3.1 of TS 36.211; N_{TA,SL} is a timing offset between sideline and timing reference frames at the UE consistent with definition in Section 9.10 of TS 36.211.

As discussed above, appropriate selection of a receive window may facilitate accurate and efficient demodulation of D2D signals. A D2D RX timing parameter T_{D2D}_{_}_{Rx} may refer to a start of an FFT window that is used to receive a D2D signal. Selection of the D2D RX timing parameter T_{D2D}_{_}_{Rx} by UE 124 may first be described with respect to the DL-based D2D signal transmit timing.

In some embodiments, the D2D RX timing parameter, which corresponds to DL-based D2D signal transmit timing, may be determined at the D2D RX by:

T_{D2D}_{_}_{RX}=T_{DL}_{_}_{RX}_{_}_{eNB1}−N_{TA,OFFSET}×Tₛ+Δ. Equation 1

T_{DL}_{_}_{RX}_{_}_{eNB1} is a DL receive timing estimated at UE 124 based on eNB 104 signals. The DL receive timing may be defined as a time when the first detected path (in time) of a corresponding DL frame is received at UE 124 from a reference cell, for example, cell 108.

N_{TA offset}, as discussed above, may be specified in section 8.1 of TS 36.211 and is the TDD-specific offset (0 for FDD). T_{S} is the sample duration (e.g., 1/(15000*2048) seconds) by which the N_{TA offset} is multiplied.

Δ is the UE-implementation-specific offset that may be used to shift the receive window. In some embodiments, the UE-implementation-specific offset may be used to adjust a receive window for an individual D2D TX timing offset; for average timing offset statistics from multiple D2D transmitters; or for potential imperfect measurement effects to, for example, compensate DL timing measurement errors at D2D TX/RX sides.

In one embodiment the Δ can be chosen equal to “−T_{CP}/2,” where T_{CP} is the D2D signal cyclic prefix (CP) duration in units of Ts.

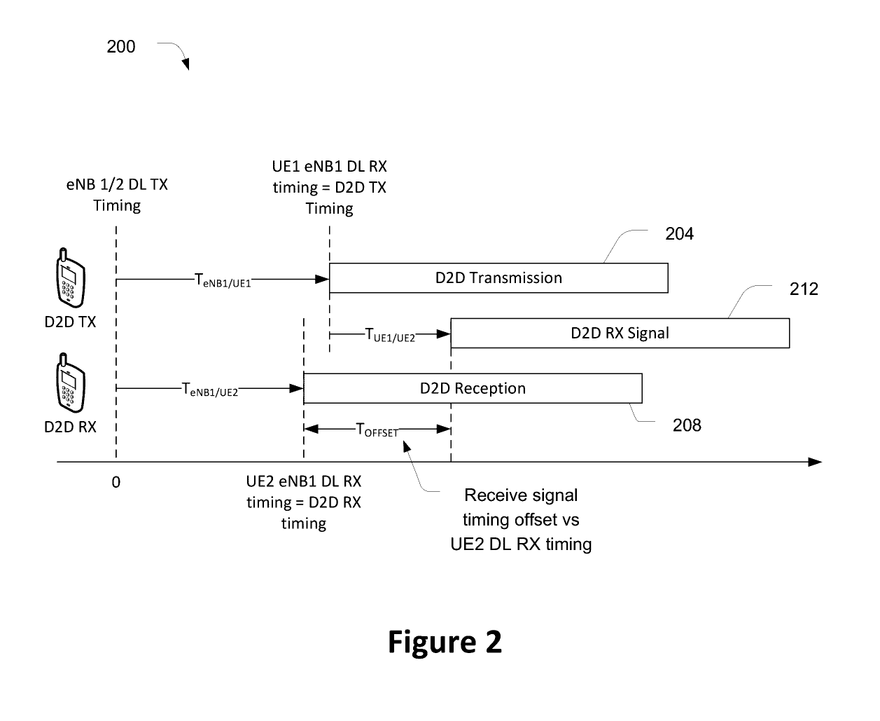

FIG. 2 illustrates a timing model 200 of D2D receive signal timing for DL-based D2D signal transmit timing in accordance with some embodiments. The timing model 200 may correspond to a simplified case in which an estimated DL receive timing is exactly equal to an eNB-to-UE propagation time. For example, a UE1 eNB1 DL RX timing estimate (for example, a DL receive timing estimated at UE 112 based on eNB 104 signals) is equal to a time that it takes for a signal to propagate from eNB 104 to UE 112. Similarly, a UE2 eNB1 DL RX timing estimate (for example, a DL receive timing estimated at UE 124 based on eNB 116 signals) is equal to a time that it takes for a signal to propagate from eNB 104 to UE 124. The UE2 eNB1 DL RX timing may correspond to T_{DL}_{_}_{Rx}_{_}_{eNB1} described above in Equation 1. The simplified case represented by timing model 200 may also assume there are no measurement errors and N_{TA offset} and Δ are zero.

In FIG. 2, time “0” may correspond to eNB 1/2 DL TX timing, which may be the eNB 104 and eNB 116 downlink transmit timing (e.g., the reference moment of time when the eNBs make the DL transmissions).

In some embodiments, the WAN DL receive timing reference point used for the DL-based D2D signal transmit timing may be UE1 eNB1 DL RX timing. Thus, the D2D TX timing (for example, a time in which the D2D TX 112 may be configured to send a D2D transmission 204) may be set equal to the UE1 eNB1 DL RX timing.

Referring to Equation 1 and setting NTA offset and Δ to zero, the D2D RX timing parameter may be set equal to the estimate of the UE2 eNB1 DL RX timing. Thus, a receiver of the UE 124 may configure its receive window to match D2D reception 208.

The D2D transmission 204 may actually arrive at the UE 124, as D2D RX signal 212, a period (T_{UE1/UE2}) after it is transmitted from the UE 112. A T_{OFFSET} may refer to a difference in time between the beginning of the D2D reception 208 and the D2D RX signal 212. In some embodiments, Δ may be set to reduce the value of T_{OFFSET} in order to move the receive window closer to the D2D RX signal 212.

In case of UL-based D2D signal transmit timing, the D2D RX timing parameter may be determined at the D2D receiver by:

T_{D2D}_{_}_{RX}=T_{DL}_{_}_{RX}_{_}_{eNB1}−N_{TA,OFFSET}×Tₛ−N_{TA}_{_}_{D2D}×T_{S}+Δ. Equation 2

T_{DL}_{_}_{RX}_{_}_{eNB1}, N_{TA,OFFSET}, Tₛ, and Δ may be similar to those terms as described above with respect to Equation 1.

N_{TA}_{_}_{D2D} may be the component responsible for D2D TX timing advance (TA) compensation. In case of reception of PSSCH from a single source in one transmission time interval (TTI), the N_{TA}_{_}_{D2D} may be set equal to the D2D TA command signaled in sidelink control information (SCI) format 0 (communicated in the PSCCH), which may be consistent with description in Timing Advance Indication of TS 36.212. In case of simultaneous reception of PSSCH from multiple sources in a TTI, the N_{TA,D2D} can take into account D2D TA commands signaled in the SCI format 0 for different D2D transmitters, respective PSCCH receive power and PSSCH PRB allocation (adjacent or not). This may be relevant if the UE is expected to receive several D2D signals in one subframe (TTI) from different D2D TX. Each D2D TX may have its own TA indication in the SCI. The D2D RX can use different strategies: (1) set N_{TA}_{_}_{D2D} equal to the largest TA signaled in different SCIs, (2) set N_{TA}_{_}_{D2D} equal to the average TA from the ones signaled in different SCIs, or (3) use weighted averaging, etc.

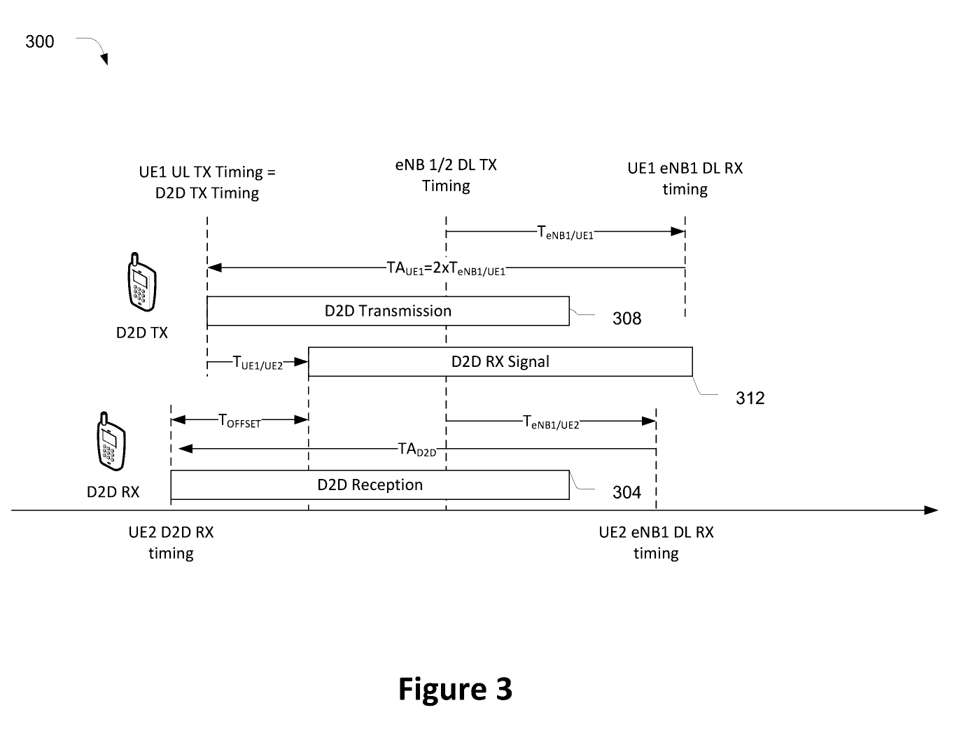

FIG. 3 illustrates a timing model 300 of D2D receive signal timing for UL-based D2D signal transmit timing in accordance with some embodiments. The timing model 300, like timing model 200, may correspond to a simplified case in which an estimated DL receive timing is exactly equal to an eNB-to-UE propagation time, there are no measurement errors, and N_{TA offset} and Δ are zero.

In this case, D2D reception 304 may be set by the UE 124 applying a TA correction N_{TA}_{_}_{D2D}×T_{S}, which may be equal to 2×T_{eNB1/UE2} with the stated assumptions of the timing model 300.

To provide the D2D transmission 308, the UE 112 may set its TA, TA_{UE1}, equal to 2×T_{eNB1/UE2} consistent with the UL-based D2D signal transmit timing procedure. The UE 124 may, at D2D RX signal 312, receive the D2D transmission 308, which may be T_{UE1/UE2} after it is sent.

T_{OFFSET} may refer to a difference in time between the beginning of the D2D reception 304 and the D2D RX signal 312. In some embodiments, Δ may be set to reduce the value of T_{OFFSET} in order to move the receive window closer to the D2D RX signal 312.

Under certain conditions, the UE 124 may receive both intra-cell D2D signals (e.g., from another UE within cell 120) and inter-cell D2D signals (e.g., from UE 112) inside one TTI. For the intra-cell D2D signals reception, the serving cell DL timing can be used as the D2D RX timing reference. Meanwhile, for the inter-cell D2D signals reception the neighboring cell signal may be used (as described above). The following approaches may address such scenarios.

In some embodiments, the UE 124 may apply one-shot single FFT receive processing. The receive signal timing can be selected: based on serving cell DL receive timing; based on the neighboring cell DL receive timing; or by using an adaptive selection of the timing between the serving and neighboring cells DL receive timing.

In some embodiments, the adaptive selection of the timing between the serving and neighboring cells DL receive timing may be given by:

T_{DL}_{_}_{RX}_{_}_{Adaptive}=T_{DL}_{_}_{RX}_{_}_{eNB1}*A+T_{DL}_{_}_{RX}_{_}_{eNB2}*B, Equation 3

where A and B are scalar weights. In a simple form, A=B=0.5, which may average the two values. Alternatively, A=0, B=1 or A=1, B=0. Other weighting values may be used in other embodiments.

Then, the DL-based D2D TX timing may be given by:

T_{D2D}_{_}_{RX}=T_{DL}_{_}_{RX}_{_}_{Adaptive}−N_{TA,OFFSET}×Ts+Δ, Equation 4

and the UL-based D2D TX timing may be given by:

T_{D2D}_{_}_{RX}=T_{DL}_{_}_{RX}_{_}_{Adaptive}−N_{TA,OFFSET}×Ts−N_{TA}_{_}_{D2D}×Ts+Δ. Equation 5

In some embodiments, the UE 124 may apply double FFT receive processing (for example, one based on the serving cell DL receive timing and another based on the neighbor cell receive timing).

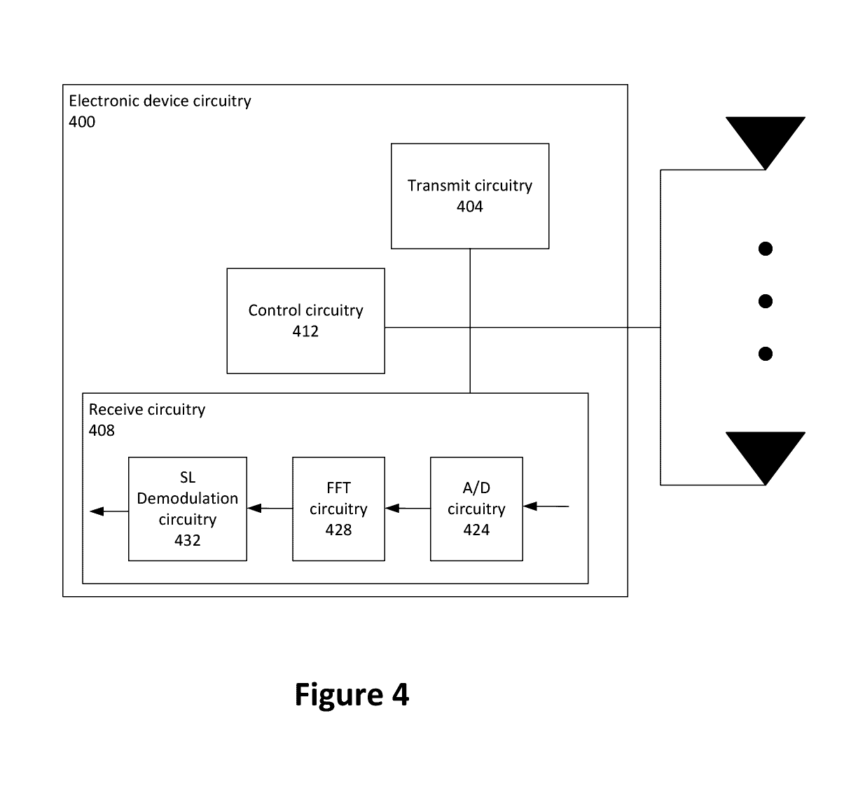

FIG. 4 illustrates electronic device circuitry 400 in accordance with some embodiments. In some embodiments, the electronic device circuitry may be, or may be incorporated into or otherwise a part of, a UE such as UE 124. In embodiments, the electronic device circuitry 400 may include transmit circuitry 404 and receive circuitry 408 coupled to control circuitry 412. In embodiments, the transmit circuitry 404 and/or receive circuitry 408 may be elements or modules of transceiver circuitry. The electronic device circuitry 400 may be coupled with one or more plurality of antenna elements of one or more antennas 416.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

The electronic device circuitry 400 and/or the components of the electronic device circuitry 400 may be configured to perform operations similar to those described elsewhere in this disclosure with respect to UE 124. In some embodiments the electronic device circuitry 400, incorporated into or otherwise part of UE 124, may be configured to perform a method of the D2D receive timing selection based on the neighboring cell DL signal receive timing measurements for the inter-cell D2D operation when D2D TX (for example, UE 112) and D2D RX (for example, UE 124) are attached to neighboring, for example, cells 108 and 120.

In particular, the control circuitry 412 may control components of the receive circuitry 408 in a manner to determine a receive window for D2D communications from UE 112 based on DL signals from the eNB 104.

The receive circuitry 408 may include analog/digital (A/D) circuitry 424 coupled with FFT circuitry 428, which is, in turn, coupled with SL demodulation circuitry 432. The A/D circuitry 424 may receive a baseband signal from the antennas 416 (via one or more intermediate components such as, for example, a downconverter) and may perform an analog-to-digital conversion. The digital baseband signal may be provided to the FFT circuitry 428. The control circuitry 412, which may be within the receive circuitry 408 in some embodiments, may determine an FFT window in which the FFT circuitry 428 will transform waveforms of the baseband signal into the frequency domain to provide a frequency-domain baseband digital sequence. In some embodiments, the control circuitry 412 may control a filter in, for example, the A/D circuitry 424 or another component to selectively transfer the signals within the receive window to the FFT circuitry 428. The SL demodulation circuitry 432 may receive the frequency-domain baseband digital signal and demodulate the signal based on the signal processing used by the D2D transmitter. The SL demodulation circuitry 432 may include such processing as, for example, channel estimation, equalization, demodulation, decoding.

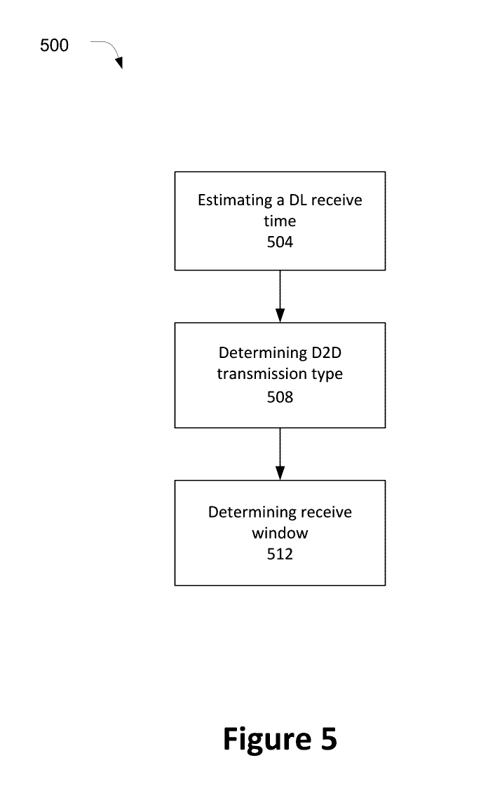

FIG. 5 is a flowchart depicting an operation 500 for determining a receive window in accordance with some embodiments. The operation 500 may be performed by UE 124. In some embodiments, the operation 500 may be performed by components of electronic device circuitry 400 including, but not limited to, control circuitry 412, A/D circuitry 424, and FFT circuitry 428.

The operation 500 may include, at 504, estimating a DL receive time. The estimate of the DL receive time may be based on DL signals transmitted by eNB 104 and received by UE 124. DL receive timing can be estimated using processing of regular DL PSS/SSS/CRS signals as a part of the cell search and synchronization procedures. The general processing flow to derive the timing estimate may involve: PSS/SSS processing (which is typically done pre-FFT in time domain); and finer timing offset post-FFT estimate using CRS processing (UE estimates the residual phase offset on symbols containing CRS and hence measures residual timing offset).

To provide a DL timing estimate for a neighboring cell, it may be desirable to process neighboring cell DL CRS signals in the frequency domain and estimate the timing offset.

In various embodiments, the estimation can be done periodically (for example, once per several frames) with potentially some filtering in time domain.

The operation 500 may include, at 508, determining a D2D transmission type. In particular, the UE 124 may determine whether a D2D transmission that it is to receive from the UE 112 is a PSSCH Mode 1 or another type of D2D transmission (for example, PSSCH Mode 2, PSCCH, PSDCH, etc.).

The operation 500 may include, at 512, determining a receive window. The receive window may be determined based on the estimated DL receive time and the D2D transmission type. In particular, if the D2D transmission type is determined, at 508, to be a PSSCH Mode 1, the UE 124 may select a receive window using DL-based D2D signal transmit timing. If the D2D transmission type is determined, at 508, to be any transmission mode other than PSSCH Mode 1, the UE 124 may select a receive window using UL-based D2D signal transmit timing.

Determining a receive window by referencing neighbor cell DL timing as described herein may result in fewer post-FFT errors observed at the D2D receiver side. For example, in a synchronous, inter-cell scenario, the inter-cell synchronization accuracy would affect the receive signal timing error in the case in which the receive timing is derived from the serving cell DL. For synchronous networks, the eNB synchronization requirements are defined in TS 36.133 (the requirements are defined for TDD networks and can be assumed similar for FDD synchronous networks). In particular, the cell-phase-synchronization accuracy measured at the base station (BS) antenna connectors may be set to be better than 3 μs for cells with radius <3 kilometers (km). Hence, the timing error imposed by imperfect eNB synchronization may be ±3 μs (±92 Ts).

The embodiments of the present disclosure that derive D2D RX timing based on the neighboring cell DL timing may not have similar errors. In particular, the cell-phase-synchronization accuracy would not affect D2D receive timing errors since both D2D TX and RX nodes derive synchronization from the same eNB.

D2D signal propagation timing may also be considered when comparing D2D RX timing based on serving or neighbor cell DL. The D2D receive signal timing offset may depend on propagation times between the eNodeB and D2D Tx/Rx nodes and between D2D Tx and Rx nodes. For the considered inter-cell D2D propagation scenarios illustrated in FIG. 1, the propagation timing offset can be estimated as follows:

D2D RX timing based on Serving cell DL: T_{offset}=T_{eNB1/UE1}−T_{eNB2/UE2}+T_{UE1/UE2}

D2D RX timing based on Neighboring cell DL: T_{offset}=T_{eNB1/UE1}−T_{eNB2/UE1}+T_{UE1/UE2}

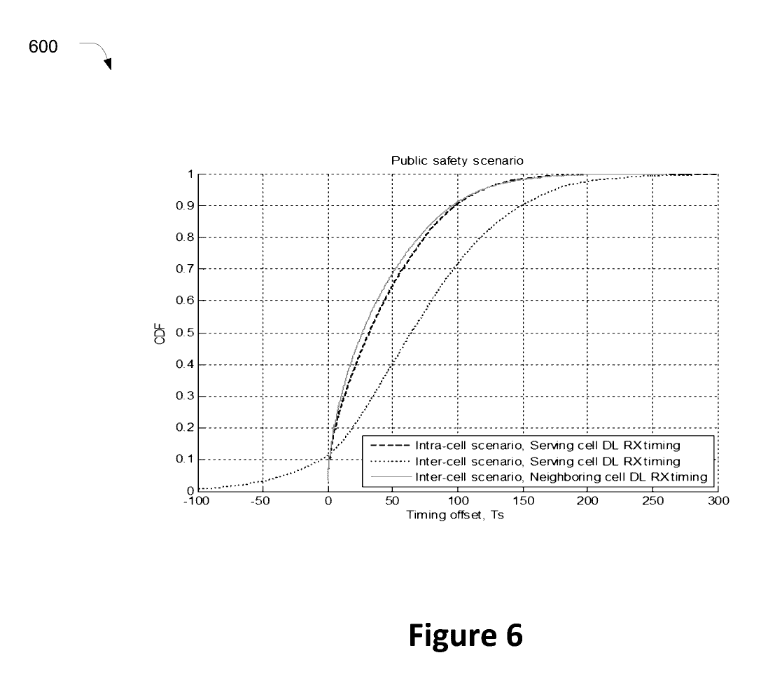

FIG. 6 is a graph 600 illustrating results of a system level analysis of a receive signal timing offset between the D2D RX timing window start and an actual received D2D signal due to propagation. In particular, graph 600 compares the timing offset cumulative distribution functions (CDFs) for the case of using two described methods of D2D RX timing selection for the inter-cell scenario. In addition, the results for the intra-cell D2D operation are provided. The following main assumptions were used for the system-level analysis: Public safety Urban macro deployment (1732 meters inter-site distance (ISD)); maximum D2D signal coupling loss is −130 dBm (with, for example, 23 dBm maximum UE transmit power and −107 dB target sensitivity).

Graph 600 illustrates that the inter-cell scenario using neighboring cell DL RX timing avoids negative timing offsets due to signal propagation effects and, furthermore, substantially reduces the positive timing offsets observed at the D2D receiver. This may improve the overall demodulation performance by the D2D receiver.

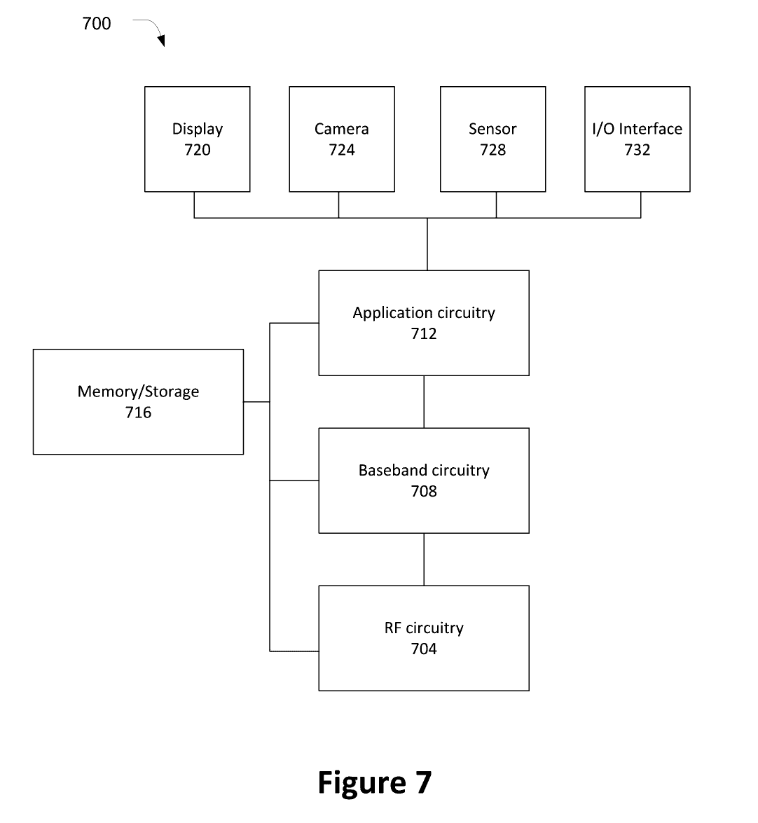

Embodiments described herein may be implemented into a system using any suitably configured hardware and/or software. FIG. 7 illustrates, for one embodiment, an example system 700 that may correspond to, and be substantially interchangeable with, UE 124 or electronic device circuitry 400. The system 700 may include radio frequency (RF) circuitry 704, baseband circuitry 708, application circuitry 712, memory/storage 716, display 720, camera 724, sensor 728, and input/output (I/O) interface 732, coupled with each other at least as shown.

The application circuitry 712 may include circuitry such as, but not limited to, one or more single-core or multi-core processors. The processor(s) may include any combination of general-purpose processors and dedicated processors (e.g., graphics processors, application processors, etc.). The processors may be coupled with memory/storage 716 and configured to execute instructions stored in the memory/storage 716 to enable various applications and/or operating systems running on the system 700.

The baseband circuitry 708 may include circuitry such as, but not limited to, one or more single-core or multi-core processors. The processor(s) may include a baseband processor. The baseband circuitry 708 may handle various radio control functions that enable communication with one or more radio networks via the RF circuitry 704. The radio control functions may include, but are not limited to, signal modulation, encoding, decoding, radio frequency shifting, etc. In some embodiments, the baseband circuitry 708 may provide for communication compatible with one or more radio technologies. For example, in some embodiments, the baseband circuitry 708 may support communication with an EUTRAN (through, e.g., cell 120) and/or other wireless metropolitan area networks (WMAN), a wireless local area network (WLAN), a wireless personal area network (WPAN) (e.g., through sidelinks with other D2D devices). Embodiments in which the baseband circuitry is configured to support radio communications of more than one wireless protocol may be referred to as multi-mode baseband circuitry.

In various embodiments, baseband circuitry 708 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

RF circuitry 704 may enable communication with wireless networks using modulated electromagnetic radiation through a non-solid medium. In various embodiments, the RF circuitry 704 may include switches, filters, amplifiers, etc. to facilitate the communication with the wireless network.

In various embodiments, RF circuitry 704 may include circuitry to operate with signals that are not strictly considered as being in a radio frequency. For example, in some embodiments, RF circuitry 704 may include circuitry to operate with signals having an intermediate frequency, which is between a baseband frequency and a radio frequency.

In various embodiments, transmit circuitry 404, control circuitry 412, and/or receive circuitry 408 discussed or described herein may be embodied in whole or in part in one or more of the RF circuitry 704, the baseband circuitry 708, and/or the application circuitry 712.

In some embodiments, some or all of the constituent components of the baseband circuitry 708, the application circuitry 712, and/or the memory/storage 716 may be implemented together on a system on a chip (SOC).

Memory/storage 716 may be used to load and store data and/or instructions, for example, for system 700. Memory/storage 716 for one embodiment may include any combination of suitable volatile memory (e.g., dynamic random access memory (DRAM)) and/or non-volatile memory (e.g., Flash memory).

In various embodiments, the I/O interface 732 may include one or more user interfaces designed to enable user interaction with the system and/or peripheral component interfaces designed to enable peripheral component interaction with the system. User interfaces may include, but are not limited to, a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments sensor 728 may include one or more sensing devices to determine environmental conditions and/or location information related to the system 700. In some embodiments, the sensor 728 may include, but is not limited to, a gyro sensor, an accelerometer, a proximity sensor, an ambient light sensor, and a positioning unit. The positioning unit may also be part of, or interact with, the baseband circuitry 708 and/or RF circuitry 704 to communicate with components of a positioning network, e.g., a global positioning system (GPS) satellite.

In various embodiments, the display 720 may include a display (e.g., a liquid crystal display, a touch screen display, etc.).

In various embodiments, the system 700 may be a mobile computing device such as, but not limited to, a laptop computing device, a tablet computing device, a netbook, an ultrabook, a smartphone, etc. In various embodiments, system 700 may have more or fewer components, and/or different architectures.

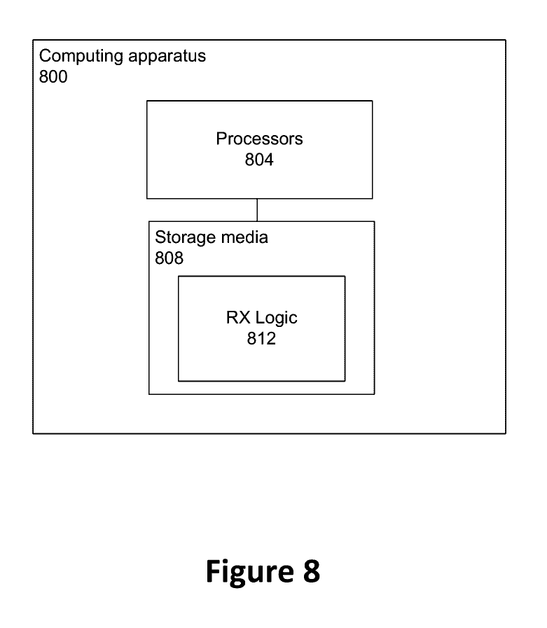

FIG. 8 illustrates a computing apparatus 800 incorporating aspects of the present disclosure in accordance with various embodiments. In various embodiments, the computing apparatus 800 may be employed to implement various embodiments of the present disclosure. As shown, the computing apparatus 800 may include a storage media 808 where RX logic 812 may be configured to practice embodiments of or aspects of embodiments of any one of the processes described herein. The storage media 808 may represent a broad range of persistent storage media known in the art, including but not limited to flash memory, dynamic random access memory, static random access memory, an optical disk, a magnetic disk, etc. In embodiments, the storage media 808 may include one or more computer-readable non-transitory storage media. In other embodiments, storage media 808 may be transitory, such as signals, encoded with RX logic 812.

In various embodiments, the RX logic 812 may enable an apparatus, for example, the UE 124, in response to its execution by one or more processors 804, to perform various operations described herein. As an example, RX logic 812 may include instructions that, when executed, control the the UE 124 to determine D2D receive signal timing based on signals from a neighbor cell.

The following paragraphs describe examples of various embodiments.

Example 1 includes one or more computer-readable media, which may be non-transitory, having instructions that, when executed, control a first user equipment (UE) to: attach to a first cell provided by a first evolved node B (eNB); estimate a downlink (DL) receive time that corresponds to a second cell provided by a second eNB; and determine a receive window to receive communications from a second UE, which is attached to the second cell provided by the second eNB, based on the estimate of the DL receive time that corresponds to the second cell.

Example 2 includes the one or more computer-readable media of example 1, wherein the instructions, when executed, further control the first UE to determine the receive window to receive communications based on a time division duplex (TDD) specific offset.

Example 3 includes the one or more computer-readable media of any one of examples 1-2, wherein the instructions, when executed, further control the first UE to determine the receive window to receive communications based on a D2D transmit timing advance (TA) compensation value.

Example 4 includes the one or more computer-readable media of example 3, wherein the D2D transmit TA compensation value is signaled in sidelink control information transmitted in a physical sidelink control channel (PSCCH).

Example 5 includes the one or more computer-readable media of example 3, wherein the instructions, when executed, further control the first UE to determine the receive window to receive communications based on a product of the D2D transmit TA compensation value and a sample duration.

Example 6 includes the one or more computer-readable media of any one of examples 1-5, wherein the instructions, when executed, further control the first UE to determine the receive window to receive communications based on an implementation specific offset to shift a timing window for individual D2D transmit timing offset, averaged timing offset statistics from multiple D2D transmitters, or to compensate for downlink timing measurement errors.

Example 7 includes the one or more computer-readable media of any one of examples 1-6, wherein the instructions, when executed, further control the first UE to determine the receive window to receive communications based on downlink-based D2D signal transmit timing.

Example 8 includes the one or more computer-readable media of any one of examples 1-7, wherein the instructions, when executed, further control the first UE to determine the receive window based on uplink-based D2D signal transmit timing.

Example 9 includes the one or more computer-readable media of any one of examples 1-8, wherein the instructions, when executed, further control the first UE to determine the receive window based on downlink-based D2D signal transmit timing.

Example 10 includes an apparatus comprising: receive circuitry to receive and process cellular and device communication signals, the receive circuitry to include fast Fourier transform (FFT) circuitry to provide a frequency-domain basedband digital sequence based on the device communication signals; and control circuitry coupled with the FFT circuitry, the control circuitry to: estimate a downlink (DL) receive time based on one or more signals from a neighbor cell; determine a transmission type of device communication signals; and determine an FFT window for the FFT circuitry to receive the device communication signals based on the estimate of the DL receive time and the transmission type.

Example 11 includes the apparatus of example 10, wherein the control circuitry is configured to determine the transmission type is a physical sidelink shared channel (PSSCH) Mode 1 transmission and to determine the FFT window using DL-based D2D signal transmit timing.

Example 12 includes the apparatus of example 11, wherein the control circuitry is configured to determine a D2D RX timing parameter (T_{D2D}_{_}_{RX}) that indicates a start of the FFT window based on: T_{D2D}_{_}_{RX}=T_{DL}_{_}_{RX}_{_}_{eNB1}−N_{TA,OFFSET}×Tₛ+Δ, where T_{DL}_{_}_{RX}_{_}_{eNB1} is the estimate of the DL receive time, N_{TA,OFFSET} is a time division duplex (TDD)-specific offset, T_{S} is a sample duration, and Δ is a user-equipment (UE)-implementation-specific offset.

Example 13 includes the apparatus of example 12, wherein the Δ is to shift the FFT window for individual D2D transmit timing offset, averaged timing offset statistics from multiple D2D transmitters, or to compensate for downlink timing measurement errors.

Example 14 includes the apparatus of example 13, wherein the Δ is equal to “−TCP/2”, where TCP is a D2D signal cyclic prefix (CP) duration.

Example 15 includes the apparatus of any one of examples 10-14, wherein the control circuitry is configured to determine the transmission type is not a physical sidelink shared channel (PSSCH) Mode 1 transmission and to determine the FFT window using UL-based D2D signal transmit timing.

Example 16 includes the apparatus of example 15, wherein the control circuitry is configured to determine a D2D RX timing parameter (T_{D2D}_{_}_{Rx}) that indicates a start of the FFT window based on: T_{D2D}_{_}_{RX}=T_{DL}_{_}_{RX}_{_}_{eNB1}−N_{TA,OFFSET}×T_{S}−N_{Ta}_{_}_{D2D}T_{S}+Δ, where T_{DL}_{_}_{RX}_{_}_{eNB1} is the estimate of the DL receive time, N_{TA,OFFSET} is a time division duplex (TDD)-specific offset, T_{S} is a sample duration, N_{TA}_{_}_{D2D} is a component to compensate for D2D TX timing advance (TA), and Δ is a user-equipment (UE)-implementation-specific offset.

Example 17 includes the apparatus of example 16, wherein the device communication signals include a PSSCH Mode 2 transmission from a single source in one transmission time interval (TTI) and N_{TA}_{_}_{D2D} is equal to a D2D TA command signaled in sidelink control information (SCI) format 0.

Example 18 includes the apparatus of example 16, wherein the device communication signals include PSSCH Mode 2 transmissions from multiple sources in a transmission time interval (TTI) and N_{TA}_{_}_{D2D} is equal to a D2D TA command signaled in sidelink control information (SCI) format 0.

Example 19 includes one or more computer-readable media, which may be non-transitory, having instructions that, when executed, control a device to: estimate a downlink (DL) receive time based on one or more signals from a neighbor cell; determine a transmission type of device communication signals; and determine a receive window for receive circuitry to receive the device communication signals based on the estimate of the DL receive time and the transmission type.

Example 20 includes the one or more computer-readable media of example 19, wherein the one or more signals from the neighbor cell include primary synchronization signals, secondary synchronization signals, or channel reference signals.

Example 21 includes the one or more computer-readable media of any one of examples 19-20, wherein the instructions, when executed, further control the device to: determine the transmission type is a physical sidelink shared channel (PSSCH) Mode 1 transmission and to determine the receive window using DL-based D2D signal transmit timing.

Example 22 includes the one or more computer-readable media of example 21, wherein the instructions, when executed, further control the device to determine a D2D RX timing parameter T_{D2D}_{_}_{RX} that indicates a start of the receive window based on:

T_{D2D}_{_}_{RX}=T_{DL}_{_}_{RX}_{_}_{eNB1}−N_{TA,OFFSET}×T_{S}+Δ, where T_{DL}_{_}_{RX}_{_}_{eNB1} is the estimate of the DL receive time, N_{TA,OFFSET} is a time division duplex (TDD)-specific offset, T_{S} is a sample duration, and Δ is a user-equipment (UE)-implementation-specific offset.

Example 23 includes the one or more computer-readable media of example 22, wherein the Δ is to shift the receive window for individual D2D transmit timing offset, averaged timing offset statistics from multiple D2D transmitters, or to compensate for downlink timing measurement errors.

Example 24 includes the one or more computer-readable media of example 23, wherein the Δ is equal to “−TCP/2”, where TCP is a D2D signal cyclic prefix (CP) duration.

Example 25 includes the one or more computer-readable media of any one of examples 19-24, wherein the instructions, when executed, further control the device to determine the transmission type is not a physical sidelink shared channel (PSSCH) Mode 1 transmission and to determine the receive window using UL-based D2D signal transmit timing.

Example 26 includes the one or more computer-readable media of example 25, wherein the instructions, when executed, further control the device to determine a D2D RX timing parameter (T_{D2D}_{_}_{Rx}) that indicates a start of the FFT window based on: T_{D2D}_{_}_{RX}=T_{DL}_{_}_{RX}_{_}_{eNB1}−N_{TA,OFFSET}×T_{S}−N_{TA}_{_}_{D2D}×T_{S}+Δ, where T_{DL}_{_}_{RX}_{_}_{eNB1} is the estimate of the DL receive time, N_{TA,OFFSET} is a time division duplex (TDD)-specific offset, T_{S} is a sample duration, N_{TA}_{_}_{D2D} is a component to compensate for D2D TX timing advance (TA), and Δ is a user-equipment (UE)-implementation-specific offset.

Example 27 includes the one or more computer-readable media of example 26, wherein the D2D signals include a PSSCH Mode 2 transmission from a single source in one transmission time interval (TTI) and N_{TA}_{_}_{D2D} is equal to a D2D TA command signaled in sidelink control information (SCI) format 0.

Example 28 includes the one or more computer-readable media of example 26, wherein the D2D signals include PSSCH Mode 2 transmissions from multiple sources in a transmission time interval (TTI) and N_{TA}_{_}_{D2D} is equal to a D2D TA command signaled in sidelink control information (SCI) format 0.

Example 29 includes a method comprising: attaching, by a first user equipment (UE), to a first cell provided by a first evolved node B (eNB); estimating a downlink (DL) receive time that corresponds to a second cell provided by a second eNB; and determining a receive window to receive communications from a second UE, which is attached to the second cell provided by the second eNB, based on the estimate of the DL receive time that corresponds to the second cell.

Example 30 includes the method of example 29, further comprising determining the receive window to receive D2D communications based on a time division duplex (TDD) specific offset.

Example 31 includes the method of any one of examples 29-30, further comprising determining the receive window to receive D2D communications based on a D2D transmit timing advance (TA) compensation value.

Example 32 includes the method of example 31, wherein the D2D transmit TA compensation value is signaled in sidelink control information transmitted in a physical sidelink control channel (PSCCH).

Example 33 includes the method of example 31, further comprising determining the receive window to receive D2D communications based on a product of the D2D transmit TA compensation value and a sample duration.

Example 34 includes the method of any one of examples 29-33, further comprising determining the receive window to receive D2D communications based on an implementation specific offset to shift a timing window for individual D2D transmit timing offset, averaged timing offset statistics from multiple D2D transmitters, or to compensate for downlink timing measurement errors.

Example 35 includes the method of any one of examples 29-34, further comprising determining the receive window to receive D2D communications based on downlink-based D2D signal transmit timing.

Example 36 includes the method of any one of examples 29-35, further comprising determining the receive window based on uplink-based D2D signal transmit timing.

Example 37 includes the method of any one of examples 29-36, further comprising determining the receive window based on downlink-based D2D signal transmit timing.

Example 38 includes a method comprising: estimating a downlink (DL) receive time based on one or more signals from a neighbor cell; determining a transmission type of device communication signals; and determining a receive window for receive circuitry to receive the device communication signals based on the estimate of the DL receive time and the transmission type.

Example 39 includes the method of example 38 wherein the one or more signals from the neighbor cell include primary synchronization signals, secondary synchronization signals, or channel reference signals.

Example 40 includes the method of any one of examples 38-39, further comprising determining the D2D transmission type is a physical sidelink shared channel (PSSCH) Mode 1 transmission and determining the receive window using DL-based D2D signal transmit timing.

Example 41 includes the method of example 40, further comprising determining a D2D RX timing parameter T_{D2D}_{_}_{RX} that indicates a start of the receive window based on: T_{D2D}_{_}_{RX}=T_{DL}_{_}_{RX}_{_}_{eNB1}−N_{TA,OFFSET}×T_{S}+Δ, where T_{DL}_{_}_{RX}_{_}_{eNB1} is the estimate of the DL receive time, N_{TA,OFFSET} is a time division duplex (TDD)-specific offset, T_{S} is a sample duration, and Δ is a user-equipment (UE)-implementation-specific offset.

Example 42 includes the method of example 41, wherein the Δ is to shift the receive window for individual D2D transmit timing offset, averaged timing offset statistics from multiple D2D transmitters, or to compensate for downlink timing measurement errors.

Example 43 includes the method of any one of examples 41-42, wherein the Δ is equal to “−TCP/2”, where TCP is a D2D signal cyclic prefix (CP) duration.

Example 44 includes the method of any one of examples 38-43, further comprising determining the D2D transmission type is not a physical sidelink shared channel (PSSCH) Mode 1 transmission and to determine the receive window using UL-based D2D signal transmit timing.

Example 45 includes the method of example 44, further comprising determining a D2D RX timing parameter (T_{D2D}_{_}_{RX}) that indicates a start of the FFT window based on: T_{D2D}_{_}_{RX}=T_{DL}_{_}_{RX}_{_}_{eNB1}−N_{TA,OFFSET}×T_{S}−N_{TA}_{_}_{D2D}×T_{S}+Δ, where T_{DL}_{_}_{RX}_{_}_{eNB1} is the estimate of the DL receive time, N_{TA,OFFSET} is a time division duplex (TDD)-specific offset, T_{S} is a sample duration, N_{TA}_{_}_{D2D} is a component to compensate for D2D TX timing advance (TA), and Δ is a user-equipment (UE)-implementation-specific offset.

Example 46 includes the method of example 45, wherein the device communication signals include a PSSCH Mode 2 transmission from a single source in one transmission time interval (TTI) and N_{TA}_{_}_{D2D} is equal to a D2D TA command signaled in sidelink control information (SCI) format 0.

Example 47 includes the method of example 45, wherein the device communication signals include PSSCH Mode 2 transmissions from multiple sources in a transmission time interval (TTI) and N_{TA}_{_}_{D2D} is equal to a D2D TA command signaled in sidelink control information (SCI) format 0.

Example 48 includes an apparatus having circuitry configured to perform any one of methods 29-47.

Example 49 includes an apparatus having means to perform any one of methods 29-47.

The description herein of illustrated implementations, including what is described in the Abstract, is not intended to be exhaustive or to limit the present disclosure to the precise forms disclosed. While specific implementations and examples are described herein for illustrative purposes, a variety of alternate and/or equivalent embodiments or implementations calculated to achieve the same purposes may be made in light of the above detailed description, without departing from the scope of the present disclosure, as those skilled in the relevant art will recognize.

What is claimed is:

1. One or more non-transitory, computer-readable media having instructions that, when executed, control a first user equipment (UE) to:
attach to a first cell provided by a first evolved node B (eNB);
estimate a downlink (DL) receive time that corresponds to a second cell provided by a second eNB; and
determine a receive window to receive communications from a second UE, which is attached to the second cell provided by the second eNB, based on the estimate of the DL receive time that corresponds to the second cell.

2. The one or more non-transitory, computer-readable media of claim 1, wherein the instructions, when executed, further control the first UE to determine the receive window to receive communications based on a time division duplex (TDD) specific offset.

3. The one or more non-transitory, computer-readable media of claim 1, wherein the instructions, when executed, further control the first UE to determine the receive window to receive communications based on a D2D transmit timing advance (TA) compensation value.

4. The one or more non-transitory, computer-readable media of claim 3, wherein the D2D transmit TA compensation value is signaled in sidelink control information transmitted in a physical sidelink control channel (PSCCH).

5. The one or more non-transitory, computer-readable media of claim 3, wherein the instructions, when executed, further control the first UE to determine the receive window to receive communications based on a product of the D2D transmit TA compensation value and a sample duration.

6. The one or more non-transitory, computer-readable media of claim 1, wherein the instructions, when executed, further control the first UE to determine the receive window to receive communications based on an implementation specific offset to shift a timing window for individual D2D transmit timing offset, averaged timing offset statistics from multiple D2D transmitters, or to compensate for downlink timing measurement errors.

7. The one or more non-transitory, computer-readable media of claim 1, wherein the instructions, when executed, further control the first UE to determine the receive window to receive communications based on downlink-based D2D signal transmit timing.

8. The one or more non-transitory, computer-readable media of claim 1, wherein the instructions, when executed, further control the first UE to determine the receive window based on uplink-based D2D signal transmit timing.

9. The one or more non-transitory, computer-readable media of claim 1, wherein the instructions, when executed, further control the first UE to determine the receive window based on downlink-based D2D signal transmit timing.

10. An apparatus comprising:
receive circuitry to receive and process cellular and device communication signals, the receive circuitry to include fast Fourier transform (FFT) circuitry to provide a frequency-domain basedband digital sequence based on the device communication signals; and
control circuitry coupled with the FFT circuitry, the control circuitry to:
estimate a downlink (DL) receive time based on one or more signals from a neighbor cell;
determine a transmission type of device communication signals; and
determine an FFT window for the FFT circuitry to receive the device communication signals based on the estimate of the DL receive time and the transmission type.

11. The apparatus of claim 10, wherein the control circuitry is configured to determine the transmission type is a physical sidelink shared channel (PSSCH) Mode 1 transmission and to determine the FFT window using DL-based D2D signal transmit timing.

12. The apparatus of claim 11, wherein the control circuitry is configured to determine a D2D RX timing parameter (T_{D2D}_{_}_{RX}) that indicates a start of the FFT window based on: T_{D2D}_{_}_{RX}=T_{DL}_{_}_{RX}_{_}_{eNB1}−N_{TA,OFFSET}×T_{S}+Δ, where T_{DL}_{_}_{RX}_{_}_{eNB1} is the estimate of the DL receive time, NTA, OFFSET is a time division duplex (TDD)-specific offset, T_{S} is a sample duration, and Δ is a user-equipment (UE)-implementation-specific offset.

13. The apparatus of claim 12, wherein the Δ is to shift the FFT window for individual D2D transmit timing offset, averaged timing offset statistics from multiple D2D transmitters, or to compensate for downlink timing measurement errors.

14. The apparatus of claim 13, wherein the Δ is equal to “−T_{CP}/2”, where T_{CP} is a D2D signal cyclic prefix (CP) duration.

15. The apparatus of claim 10, wherein the control circuitry is configured to determine the transmission type is not a physical sidelink shared channel (PSSCH) Mode 1 transmission and to determine the FFT window using UL-based D2D signal transmit timing.

16. The apparatus of claim 15, wherein the control circuitry is configured to determine a D2D RX timing parameter (T_{D2D}_{_}_{RX}) that indicates a start of the FFT window based on:
T_{D2D}_{_}_{RX}=T_{DL}_{_}_{RX}_{_}_{eNB1}−N_{TA,OFFSET}×T_{S}−N_{TA}_{_{D2D}}×T_{S}+Δ, where T_{DL}_{_}_{RX}_{_}_{eNB1} is the estimate of the DL receive time, N_{TA,OFFSET} is a time division duplex (TDD)-specific offset, T_{S} is a sample duration, N_{TA}_{_}_{D2D} is a component to compensate for D2D TX timing advance (TA), and Δ is a user-equipment (UE)-implementation-specific offset.

17. The apparatus of claim 16, wherein the device communication signals include a PSSCH Mode 2 transmission from a single source in one transmission time interval (TTI) and N_{TA}_{_}_{D2D} is equal to a D2D TA command signaled in sidelink control information (SCI) format 0.

18. The apparatus of claim 16, wherein the device communication signals include PSSCH Mode 2 transmissions from multiple sources in a transmission time interval (TTI) and N_{TA}_{_}_{D2D} is equal to a D2D TA command signaled in sidelink control information (SCI) format 0.

19. One or more non-transitory, computer-readable media having instructions that, when executed, control a device to:
estimate a downlink (DL) receive time based on one or more signals from a neighbor cell;
determine a transmission type of device communication signals; and
determine a receive window for receive circuitry to receive the device communication signals based on the estimate of the DL receive time and the transmission type.

20. The one or more non-transitory, computer-readable media of claim 19, wherein the one or more signals from the neighbor cell include primary synchronization signals, secondary synchronization signals, or channel reference signals.

21. The one or more non-transitory, computer-readable media of claim 19, wherein the instructions, when executed, further control the device to: determine the transmission type is a physical sidelink shared channel (PSSCH) Mode 1 transmission and to determine the receive window using DL-based D2D signal transmit timing.

22. The one or more non-transitory, computer-readable media of claim 21, wherein the instructions, when executed, further control the device to determine a D2D RX timing parameter (T_{D2D}_{_}_{RX}) that indicates a start of the receive window based on: T_{D2D}_{_}_{RX}=T_{DL}_{_}_{RX}_{_}_{eNB1}−N_{TA,OFFSET}×T_{S}+Δ, where T_{DL}_{_}_{RX}_{_}_{eNB1} is the estimate of the DL receive time, NTA, OFFSET is a time division duplex (TDD)-specific offset, T_{S} is a sample duration, and Δ is a user-equipment (UE)-implementation-specific offset.

23. The one or more non-transitory, computer-readable media of claim 22, wherein the Δ is to shift the receive window for individual D2D transmit timing offset, averaged timing offset statistics from multiple D2D transmitters, or to compensate for downlink timing measurement errors.

24. The one or more non-transitory, computer-readable media of claim 23, wherein the Δ is equal to “−T_{CP}/2”, where T_{CP} is a D2D signal cyclic prefix (CP) duration.

25. The one or more non-transitory, computer-readable media of claim 19, wherein the instructions, when executed, further control the device to determine the transmission type is not a physical sidelink shared channel (PSSCH) Mode 1 transmission and to determine the receive window using UL-based D2D signal transmit timing.
